(19) United States
(12) Patent Application Publication
(10) Pub. No.: US 2007/0261799 A1
(43) Pub. Date: Nov. 15, 2007

(54) Sliding panel

(76) Inventor: Chen-Ho Chu, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/526,087

(22) Filed: Sep. 25, 2006

(30) Foreign Application Priority Data
May 12, 2006 (TW) 095116895

(51) Int. Cl. E05D 15/06

(52) U.S. Cl. 160/197

(57) ABSTRACT

A sliding panel includes multiple connecting/adjacent carrier tracks such as two/three/four carrier tracks while connectors of each carrier track are disposed in opposite directions or at intervals. Thus the multiple connecting/adjacent carrier tracks slide in parallel under the same channel. Moreover, the positions of each connector on top surface of respective carrier track are in alternating arrangement so as to allow runners of multiple connecting/adjacent carrier tracks being mounted inside the same channel simultaneously. The runners of the connecting/adjacent carrier tracks move inside the channel of a rail at the same time and the connecting/adjacent carrier tracks slide in parallel under the same channel. Therefore, the number of channels of the rail is decreased and the amount of material used for producing the rail is reduced. Furthermore, the rail can be designed to have two-step inner and outer rails for adjusting length of the rail. Moreover, each rail is disposed only with one channel and then a plurality of rails such as one/two/three rails are arranged in parallel to form a rail set for easy assembling.

### BACKGROUND OF THE INVENTION

The present invention relates to a sliding panel, especially to a sliding panel that uses a single channel on a rail for accommodation of a plurality of carrier tracks simultaneously sliding in parallel.

A sliding panel is one kind of screen and is composed of a rail, a plurality of carrier tracks mounted under the rail, a plurality of panels attached on the carrier track respectively. Two separating connectors are arranged on top surface of, each carrier tracks while a runner such as a caster is connected on top of the connector. By inserting the connector upwards through a channel opening on bottom of the rail, the runner slides inside the channel of the rail.

Thus each of the carrier tracks and panels thereof slides transversely so as to make the panels extend or retract, overlapping with one another. There is a small overlapping area between the two connecting/adjacent panels after being extended so that the multiple panels form a continuous surface to achieve better shielding effect. Moreover, most of conventional sliding panels include one rail with a plurality of channels while each of the channels is disposed with a corresponding carrier track. The number of channels mounted on the rail depends on the width of the sliding panel. For example, there may be three, four, five or six channels on the rail of the sliding panel and each channel has a corresponding opening for insertion of the connector of the carrier track.

In market of fixed-size curtains, once the construction of the products allows users to adjust the size, the sales volume increase. In traditional sliding panels, one rail is disposed with a plurality of channels. Once the rail is designed into an extendable rail consisting of an inner rail and an outer rail, it is difficult to form the extrusion of the rails precisely, so that the rails can't be telescoped smoothly. Furthermore, because of the bulky sizes of the rails, they need more material and cost more money. By using the one rail one channel construction, it is easier to form the extrusion of the inner and outer rails precisely, so that the rails can be telescoped smoothly. But again you meet another problem, for sliding panel with 3 to 6 rails, it needs a lot of material and cost a lot of money. Furthermore, it is difficult to combine 3 to 6 rails and install them together.

### SUMMARY OF THE INVENTION

Therefore it is a primary object of the present invention to provide a sliding panel that includes multiple connecting/adjacent carrier tracks such as two/three/four carrier tracks while connectors of each carrier track are disposed in opposite directions and/or at intervals. Thus the multiple connecting/adjacent carrier tracks slide in parallel under the same channel. Moreover, the positions of each connector on top surface of respective carrier track are in alternating arrangement so as to allow runners of multiple connecting/adjacent carrier tracks being mounted inside the same channel simultaneously. The runners of several connecting/adjacent carrier tracks move inside the channel of a rail at the same time so that the connecting/adjacent carrier tracks slide in parallel under the same channel for extending or retracting the sliding panel. Therefore, in a set of sliding panel, the number of channels of the rails is decreased and the amount of material used for producing the rail is reduced.

It is the other object of the present invention to provide a sliding panel that includes a channel on each rail and a rail set formed by at least one rail (such as one, two or three rails) arranged in parallel so as to meet requirements of simplified rail set formation, precision, and easy assembling.

It is another object of the present invention to provide a sliding panel whose rail is composed of inner and outer rails so that the inner rail can be pulled out of the outer rail for adjusting length of the rail.

### BRIEF DESCRIPTION OF THE DRAWINGS

FIG. 1 is a perspective view of an embodiment having one rail and two carrier tracks in accordance with the present invention;

FIG. 2A is an explosive view of the embodiment in FIG. 1;

FIG. 2B is a schematic drawing showing the alternating arrangement of the connector's position on two connecting/adjacent carrier tracks in the same channel.

FIG. 3 is a side view of the embodiment in FIG. 1;

FIGS. 4A, 4 B respectively are cross sectional views of connectors of the two carrier tracks in FIG. 3;

FIG. 5 is the other side view of the embodiment in FIG. 3;

FIG. 6 is a perspective view of another embodiment having two rails and four carrier tracks in accordance with the present invention;

FIG. 7 is an explosive view of the embodiment in FIG. 6;

FIG. 8 is a perspective view showing separated carrier tracks of the embodiment in FIG. 7;

FIG. 9 is a perspective view showing the carrier tracks of the embodiment in FIG. 7 being arranged in parallel and overlapped with one another;

FIGS. 10A, 10B are side views of the embodiment in FIG. 7;

FIGS. 11A, 11B are perspective views of another embodiment having one rail and three carrier tracks in accordance with the present invention;

FIG. 12 is an explosive view of the embodiment in FIG. 11;

FIG. 13 is a perspective view of separated carrier tracks of the embodiment in FIG. 12;

FIG. 14 is a side view of the embodiment in FIG. 11A;

FIG. 15A, FIG. 15B, FIG. 15C are cross-sectional views of the three connectors of carrier tracks in accordance with the embodiment in FIG. 14;

FIG. 16 is the other side view of the embodiment in FIG. 14.

FIG. 17 is a perspective view showing a fixing clip disposed between an outer rail and two inner rails of the embodiment in FIG. 7;

FIG. 17A is an assembling view of the embodiment in FIG. 17;

FIG. 17B is a perspective view showing the embodiment in FIG. 17 being used (after being fixed);

FIG. 18 is a top view showing a measuring tape disposed on an inner rail of the rail set of the embodiment in FIG. 7.

### DETAILED DESCRIPTION OF THE PREFERRED EMBODIMENT

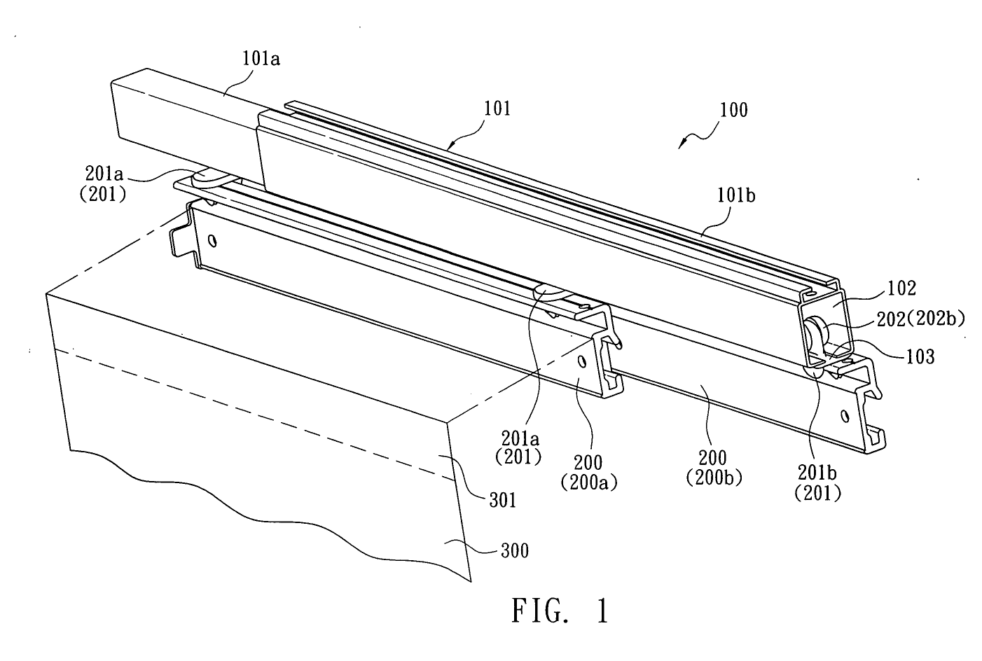

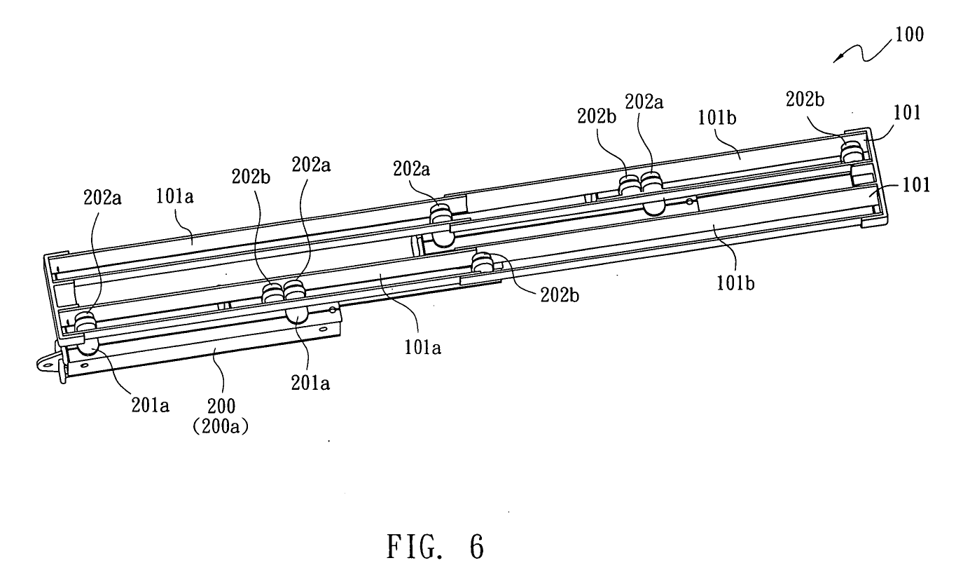

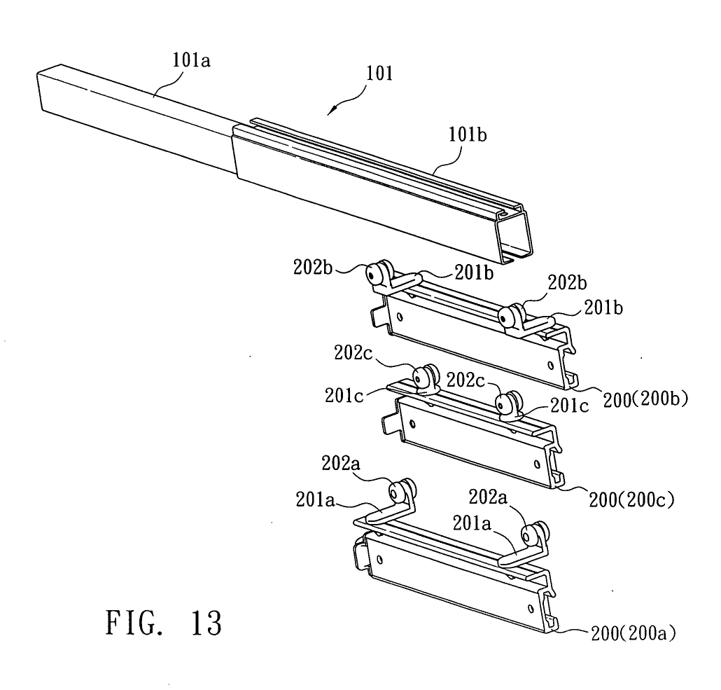

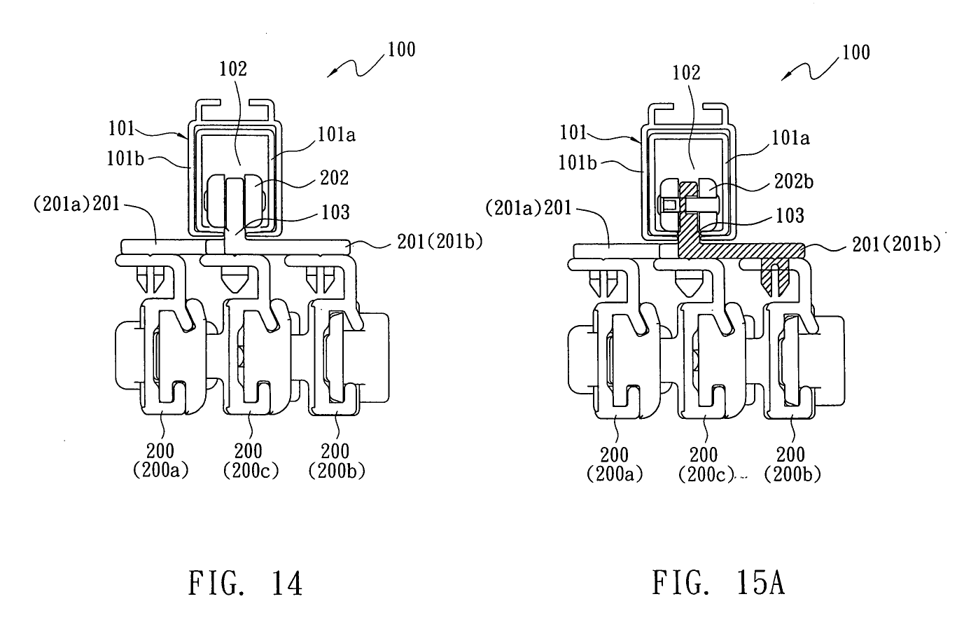

Refer to FIG. 1-16, a sliding panel in accordance with the present invention consists of a rail set 100, a plurality of carrier tracks 200 and a plurality of panels 300. The rail set 100 includes at least one such as two or three rails 101 arranged in parallel while each of the panels 300 is attached on one of the carrier tracks 200 by the top surface 301 thereof, as shown in FIG. 1 & FIG. 6. Each carrier track 200 and the panel 300 thereon slide under a channel 102 of the rail 101 for extending or retracting the sliding panel. Connectors 201 are disposed on top surface of each carrier track 200. Generally, one carrier track 200 is disposed with two connectors 201 and a runner 202 such as a caster or other part able to slide inside the channel 102 is connected on top of the connector 201. By the connector 201 inserting through an channel opening 103 on bottom of the rail 101, the runner 202 slides inside the channel 102 of the rail 101 and further the carrier tracks 200 as well as the panel under the channel 102 are driven to move for extending or retracting.

The present invention is mainly characterized in that multiple (two, three or four) connecting/adjacent carrier tracks 200 are used and connectors 201 of each carrier track 200 are disposed in opposite directions and/or at intervals so that multiple carrier tracks 200 are able to slide parallel under the same channel 102. Moreover, the connectors 201 are arranged alternatingly on top surface of each carrier track 200 so as to make runners 202 of multiple connecting/adjacent carrier tracks 200 slide simultaneously inside the same channel 102. And a plurality of carrier tracks 200 disposed under the same channel 102 slide parallel for extending or retracting.

It's another feature of the present invention that only a single channel 102 is arranged on each of the rail 101. Then at least one or a plurality of rails 101 such as one, two or three are disposed in parallel to form a rail set 100 to achieve requirements of simplified rail set formation, precision, and easy assembling.

It's a further feature of the present invention that the rail 101 consists of two-step type rails—an inner and an outer rail 101a, 101b. Thus the inner rail 101a can be pulled out from the outer rail 101b for extending length of the rail. Therefore, length of the rail 101 is adjustable. Moreover, the function that a channel 102 of a rail 101 holds a plurality of carrier tracks arranged in parallel is not influenced by such design of the rail 101 composed of inner rail 101a and outer rail 101b.

As to the fact that multiple carrier tracks 200 and the panels 300 thereof slide parallel under the channels 102 of the rails 101, basically it is necessary to be operated by other driving mechanism and positioning mechanism disposed over the sliding panels. Thus each of the carrier tracks 200 and the panels 300 thereof are sliding transversely in sequence for being extending into an open or half-open pattern or sliding in reverse direction for being retracted into a stacked status. However, above driving mechanism and positioning mechanism with various designs are not features of the present invention and will not be described in details.

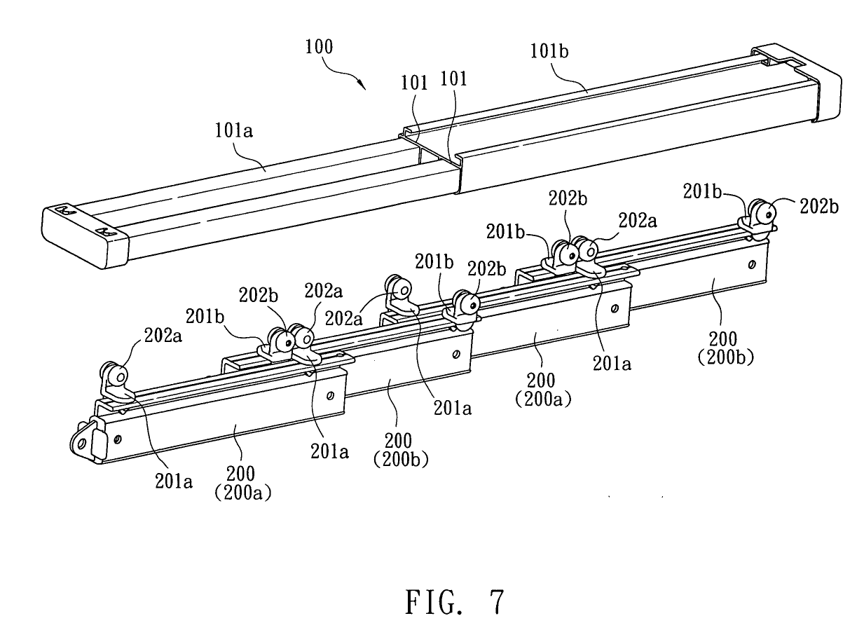

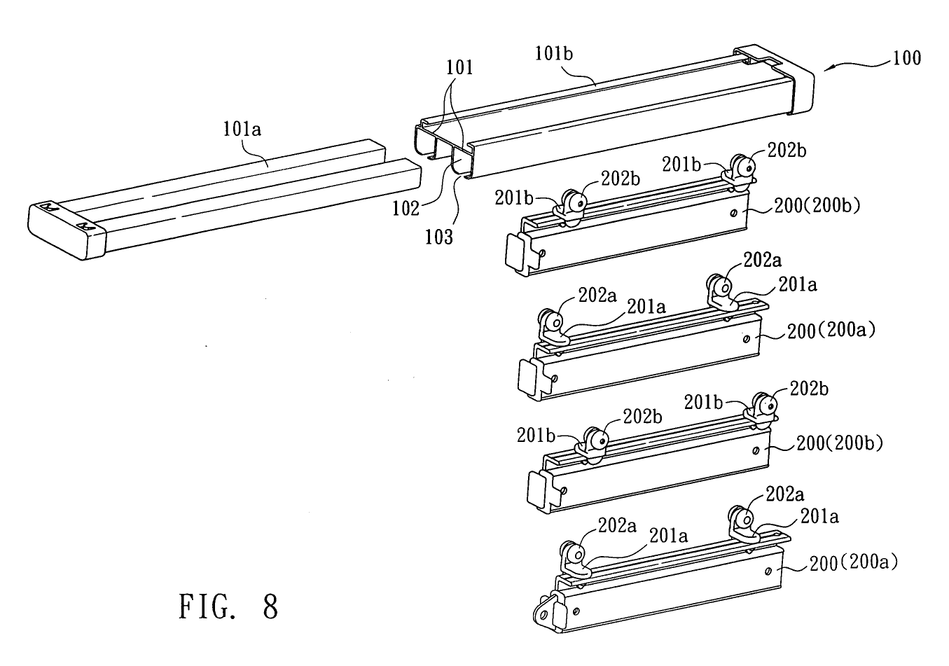

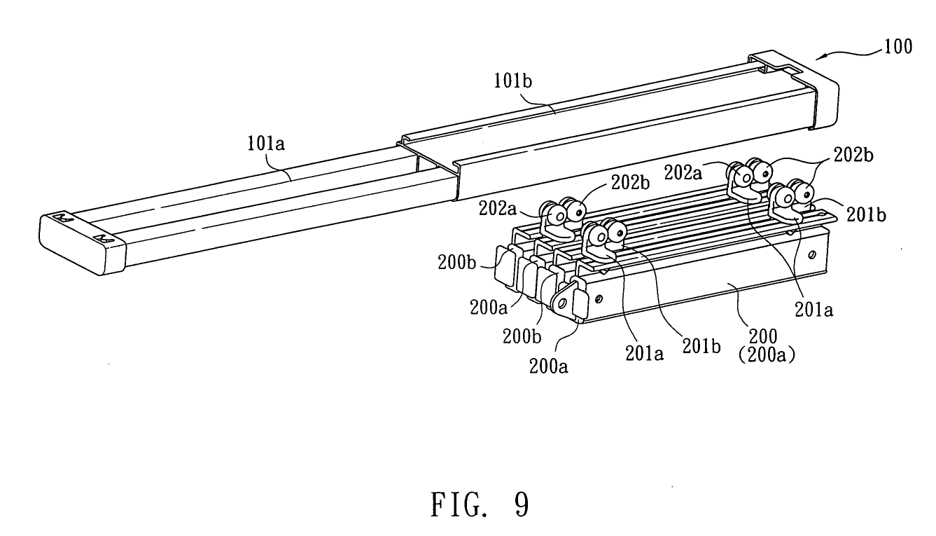

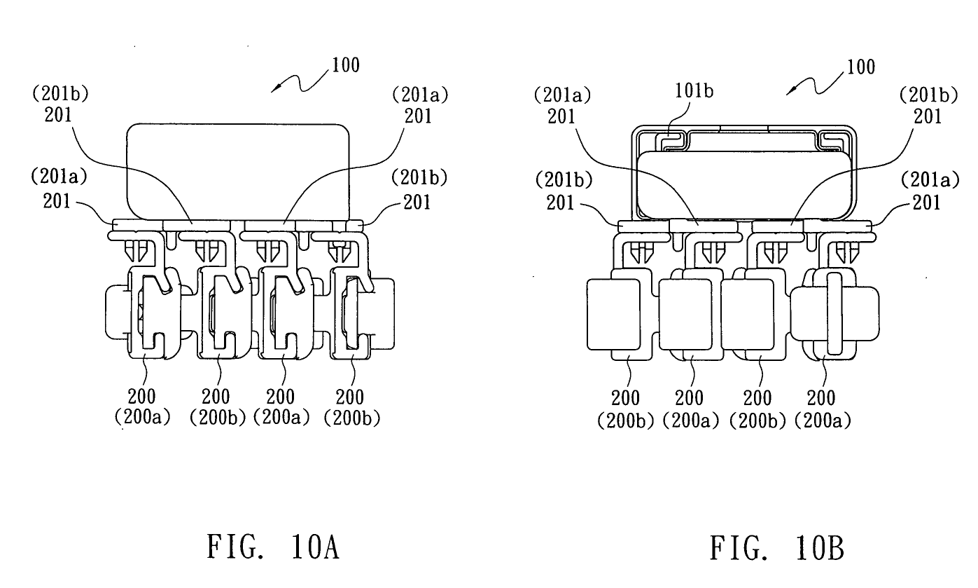

In addition, the rail set 100 is composed of at least one (1/2/3) rail 101. The outer rail 101b of each of the rail 101 is integrated, as shown in FIG. 7, FIG. 8 & FIG. 9, or secured by a fastening member so that several separated outer rails 101b are fastened into one body and a plurality of separated, parallel channels 102 is formed. Thus a plurality of inner rails 101a is respectively mounted in each of the separated channels 102 for being pulled out to elongate the length of the rail 101.

### Embodiment 1

Refer to FIG. 1 to FIG. 5, only a single channel 102 is disposed on a rail 101 while two carrier tracks 200 are arranged in parallel under the single channel 102. The rail set 100 of this embodiment is composed of a rail 101.

The two connectors 201a, 201b are disposed in opposite direction on two carrier tracks 200a, 200b of the two connecting/adjacent panels 300. Right end of the connector 201a of the left carrier track 200a inserts through the channel opening 103 of the rail 101 and connects to one runner 202a while left end of the connector 201b of the right carrier track 200b inserts through the channel opening 103 of the rail 101 and connects to one runner 202b. Thus the right connector 201b and left connector 201a are respectively located under left and right sides under the channel opening 103 of the channel 102. Furthermore, left and right carrier tracks 200a, 200b respectively connecting with the left and right connectors 201a, 201b are disposed in parallel on left and right sides under the channel opening 103 of the channel 102, and are sliding parallel to each other together with the two panels 300 they support.

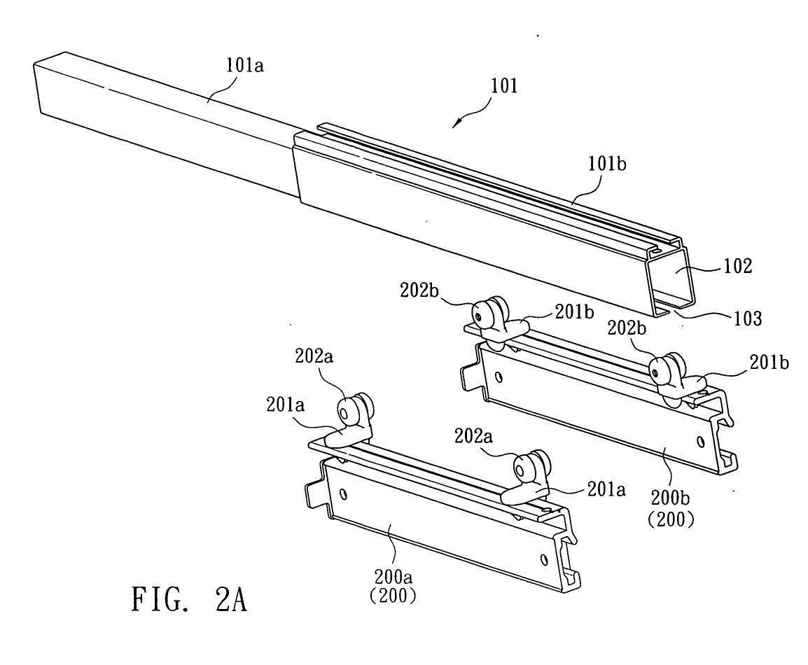

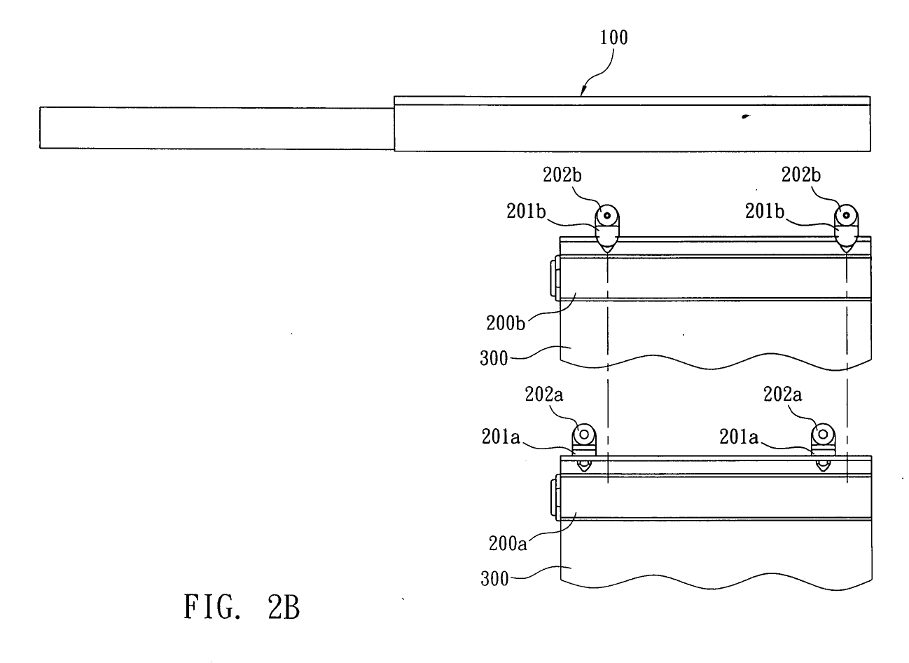

Moreover, the way to dispose the two connectors 201a, 201b as well as the runners 202a, 202b on top surface of the left and right carrier tracks 200a, 200b is placed on alternating positions. The said alternating arrangement is that the two connectors 201a, 201b and the runners 202a, 202b thereof are following in turns, succeeding each other, at certain intervals, as shown in FIG. 2A & FIG. 2B. The positions of the connector 201a, 201b disposed on the two carrier tracks 200a, 200b are not symmetrical. When the connector 201a is disposed on a certain position of the carrier track 200a, the corresponding connector 201b is disposed on the connecting/adjacent carrier track 200b, away from the corresponding position of the connector 201a, as shown in FIG. 2A & FIG. 2B. Thus the runners 202a, 202b slide simultaneously inside a single channel 102 of the rail 101. Therefore, the two connecting/adjacent carrier tracks 200a, 200b slide in parallel under the same channel 102 for extending or retracting the sliding panels.

### Embodiment 2

Refer to FIG. 6 to FIG. 10A, 10B, four carrier tracks 200 are disposed in parallel under two channels 102 of the two rails 101. The rail set 100 of this embodiment includes two rails 101. This embodiment is formed by two sets of the embodiment 1. The runners 202a, 202b, of the two carrier tracks 200a, 200b are simultaneously mounted and sliding in side a channel 102 of each of the two rails 101. Thus the two connecting/adjacent carrier tracks 200a, 200b are respectively slides under each of the channels 102 in parallel. Moreover, by the driving mechanism and the positioning mechanism disposed on the sliding panel, two sets of the two carrier tracks 200a, 200b, total four carrier tracks-200a, 200b, 200a, 200b are moving in parallel under the rail set 100 composed of two rails 101 so as to be extended or retracted, overlapping with one another.

### Embodiment 3

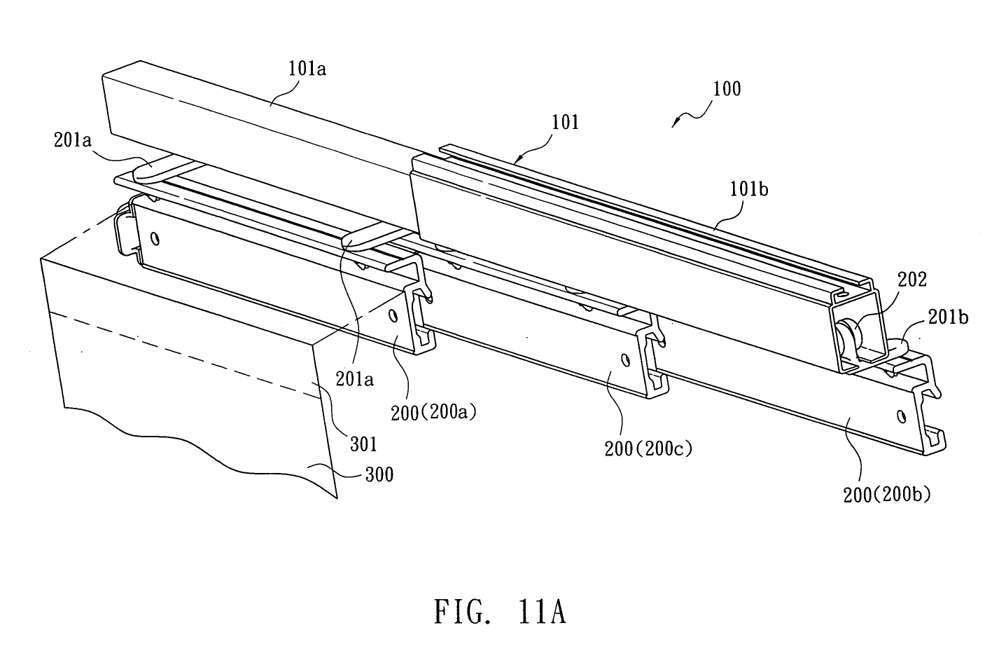

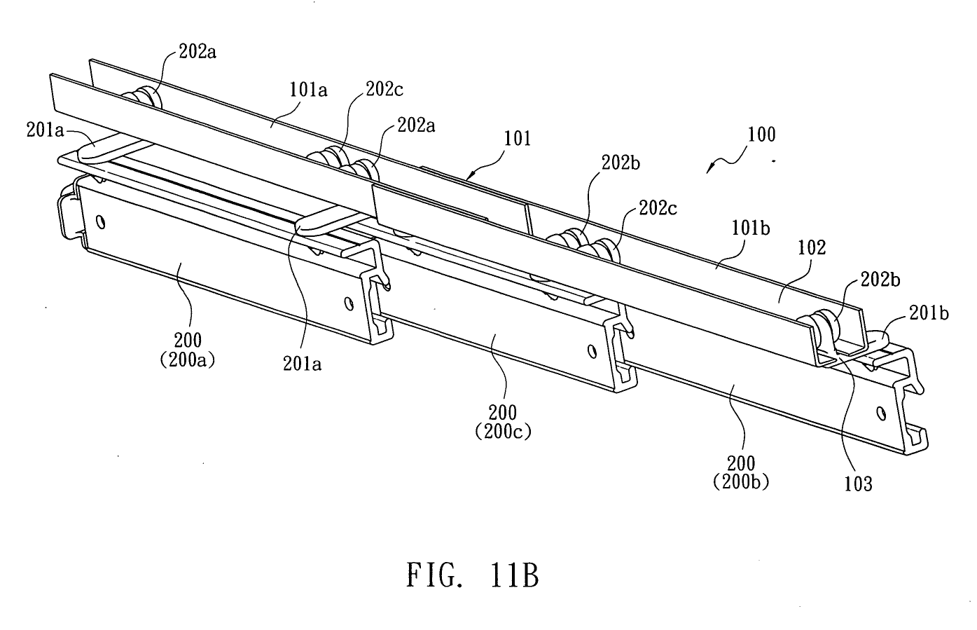

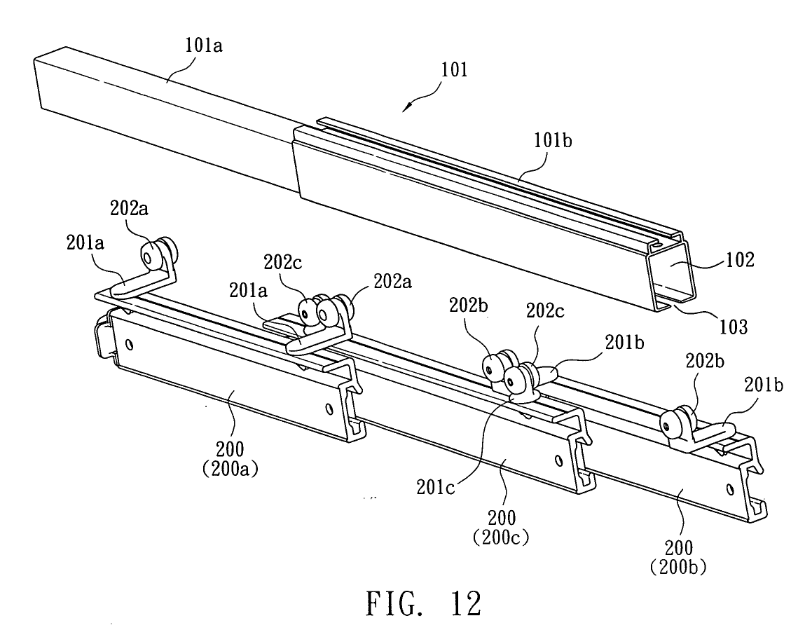

Refer to FIG. 11A to FIG. 16, only one channel 102 is mounted on a rail 101 and there are three carrier tracks 200 arranged and sliding in parallel under the channel 102. The rail set 100 of this embodiment consists of one rail 101. The difference between this embodiment and the embodiment 1 is that a set of two connecting/adjacent carrier tracks 200a, 200b and the panels 300 thereof is replaced by a set of three connecting/adjacent carrier tracks 200a, 200c, 200b and the panels 300 thereof. The connectors 201a, 201c, 201b respectively disposed on the three carrier tracks 200a, 200c, 200b of the three connecting/adjacent panels 300 are arranged in opposite direction or at intervals. The distance between the left and right carrier tracks 200a, 200b is enlarged so as to add a middle carrier track 200c as well as a panel 300 therein. An alternating connector 201c is arranged between the two connectors 201a, 201b disposed in opposite directions. Middle part of the connector 201c of the middle carrier track 200c inserts through the channel opening 103 of the rail 101 for connecting with a runner 202c. Thus the left, middle and right connectors 201a, 201c, 201b are respectively located at the left, middle and right positions under the channel opening 103 of the channel 102 on the rail 101. Therefore, the left, middle and right carrier cracks 200a, 200c, 200b are arranged in parallel under the channel opening 103 and are sliding parallel to one another.

In addition, the three connectors 201a, 201c, 201b together with the runners 202a, 202c, 202b thereof are respectively arranged on top surface of the carrier tracks 200a, 200c, 200b in an alternating way, like the arrangement of embodiment 1 so as to make the runners 202a, 202c, 202b of the three connecting/adjacent carrier tracks 200a, 200c, 200b slide simultaneously inside the same channel 102. Thereby, the single channel 102 of the rail 101 allows the runners 202a, 202c, 202b of the three carrier tracks 200a, 200c, 200b to move at the same time therein so that the three carrier tracks 200a, 200c, 200b slide in parallel under the same channel 102 for extending or retracting the sliding panel.

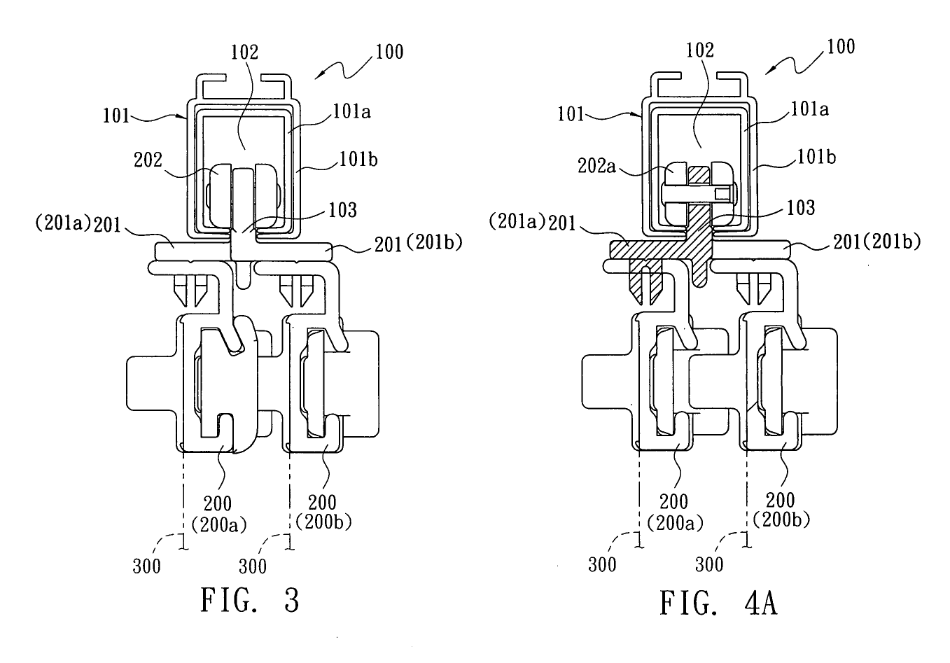

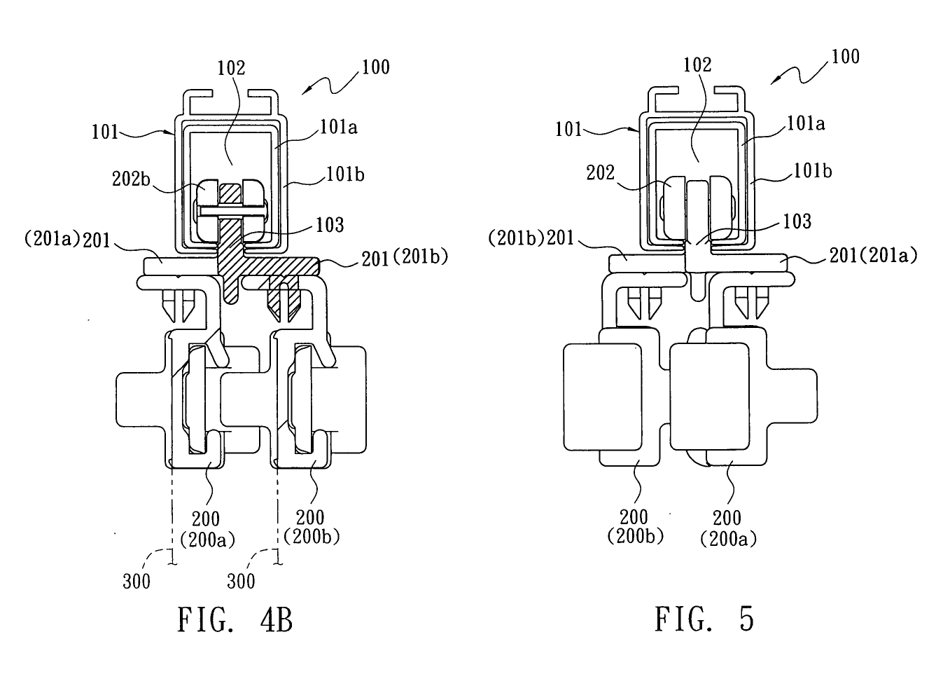

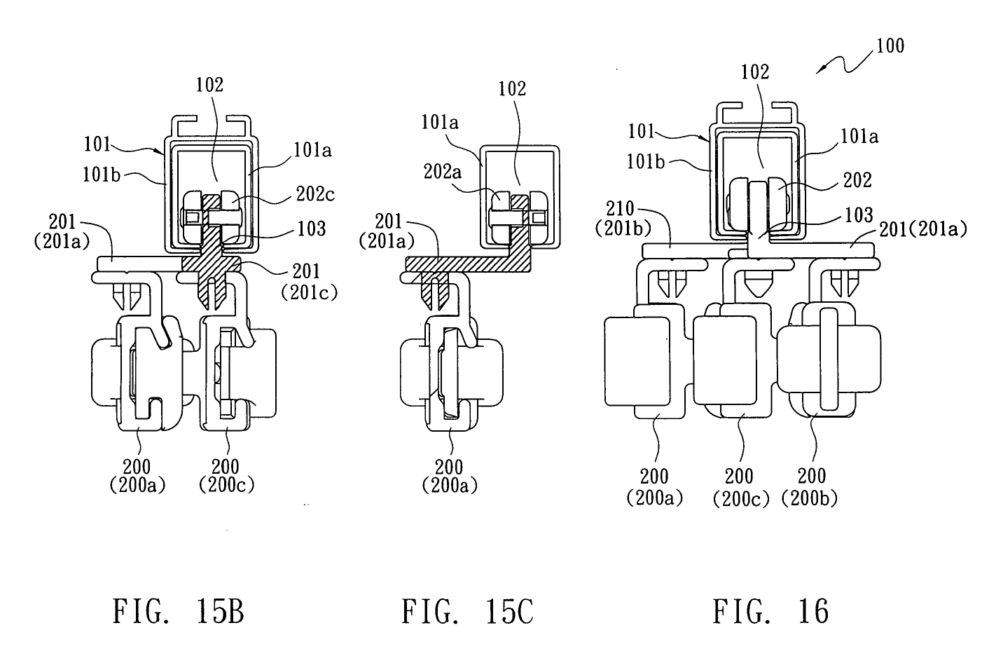

Refer to FIG. 3, FIG. 4A, FIG. 4B, FIG. 14 and FIG. 15A to FIG. 15C, the rail 101 consists of an inner rail 101a and an outer rail 101b. When the inner rail 101a is pulled out from the outer rail 101b for extending length of the rail, there is a height difference between the inner rail 101a and the outer rail 101b while the height difference equals to thickness of the inner rail 101a. The distance between the bottom of the runner 202 and each of the connectors 201 that inserts through the channel opening 103 on bottom of the rail 101 is no less than the total thickness of the inner and the outer rails 101a, 101b so that the connector 201 will not be locked or stopped while passing through the overlapping area of the inner rail 111a and the outer rail 101b. Moreover, the runner 202 is preferable a caster so that when the runner 202 slides forwards and backwards inside the channel 102 of the rail, it can moves smoothly through the height difference between the inner rail 101a and the outer rail 101b.

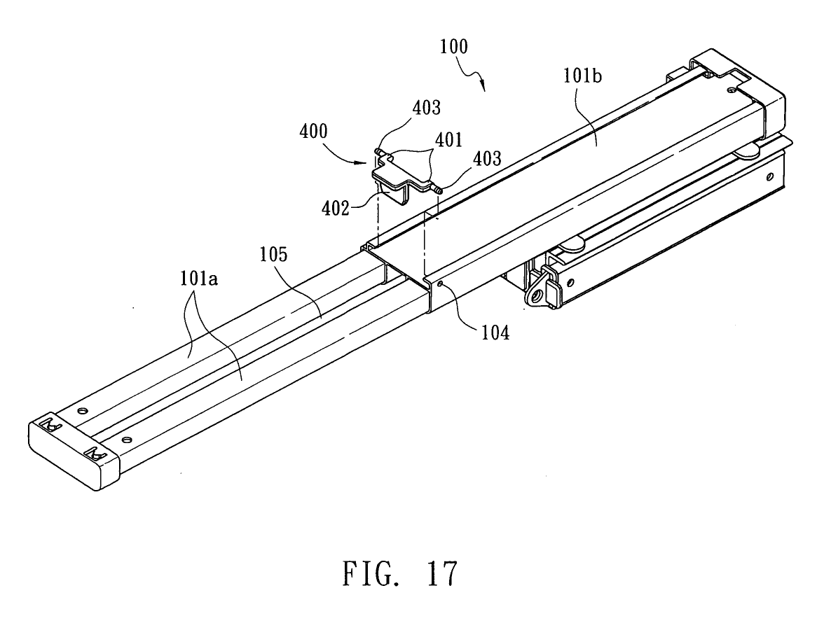

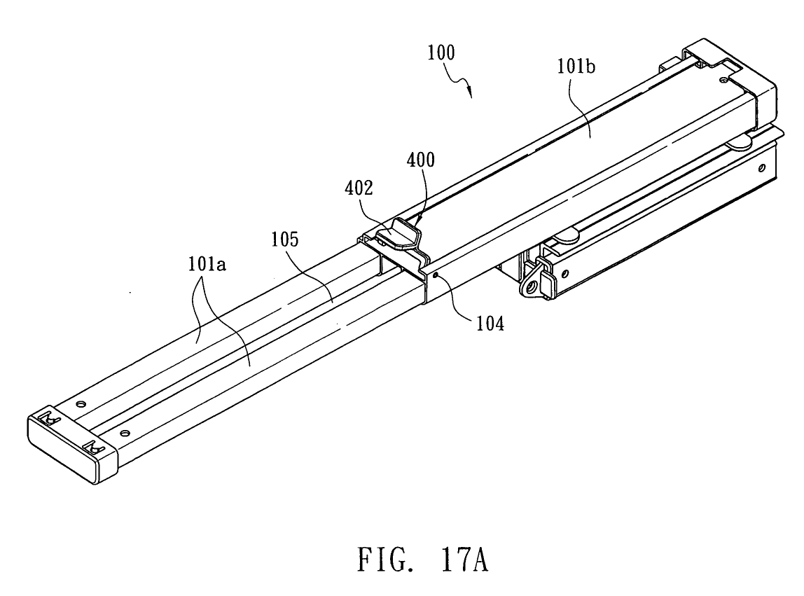

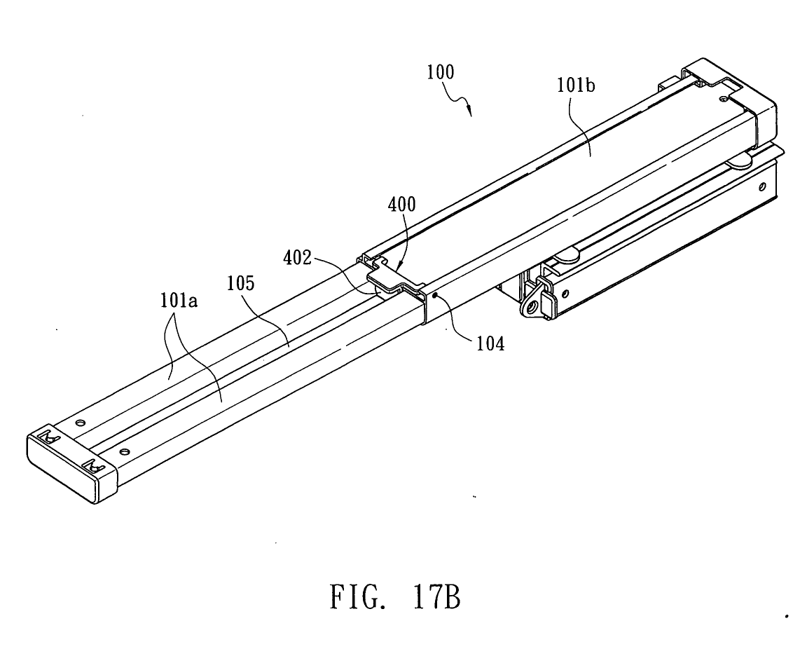

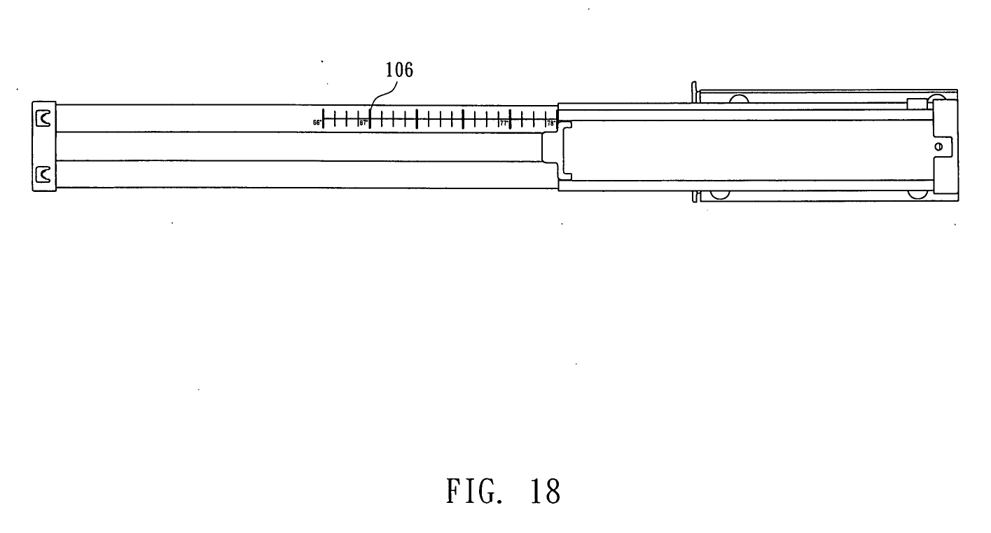

Refer to FIG. 17 to FIG. 17B, a fixing clip 400 is disposed between the outer rail 101b and the inner rail 101a. The fixing clip 400 having two symmetrical arms 401 and a stopping block 402 is made from plastic injection molding. A projecting rod 403 is disposed on rear end of each of the arm 401. The two symmetrical projecting rods 403 inserts into two symmetrical holes 104 on top surface of the outer rail 101b by elasticity of the two arms 401 so that the fixing clip 400 is fixed on the outer rail 101b and is pivotable. Refer to FIG. 17A, when the two inner rails 101a are pulled out of the outer rail 101b to the required length synchronously, users can rotate the fixing clip 400 to make the stopping block 402 insert into a gap 105 between the two inner rails 101a, as shown in FIG. 17B. Thus both the outer rail 101b and the two inner rails 101a are fixed. The fixed rail length is convenient for subsequently assembling of the rail set 100. Moreover, refer to FIG. 18, a measuring tape 106 is disposed on top surface of the inner rail 101a for convenience of users to adjust length of rails.

In summary, the present invention has a rail 101 and a channel 102 disposed with a plurality of carrier tracks 200. Once a rail set 100 of the present invention consists of two rails 101 arranged in parallel, it allows disposition of four or six panels 300 thereof. If the rail set 100 includes three rails 101 arranged in parallel, it allows disposition of six or nine panels 300 thereof. Thus the number of the rails 101 being used by the present invention is only a half or one third of the number of the panels 300. Or in the similar way, the ratio can be one fourth (a channel 102 disposed with four carrier tracks 200). Moreover, the length of the rail is adjustable. Compared with conventional structure that a rail with certain length, having multiple channels while each channel only disposed with one carrier track, the present invention has better application.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A sliding panel comprising:
a rail set having at least one rail arranged in parallel;
a plurality of carrier tracks mounted under the rail, a plurality of panels respectively attached on each of the carrier tracks;
two connectors disposed on top surface of each carrier track;
a runner jointed on top of each connector;
by the connector inserted upwards through a channel opening on bottom of the rail so as to make the runner slide inside a channel of the rail and further the carrier track as well as the panel thereof are driven to slide in parallel under the channel for extending or retracting the sliding panel; the sliding panel is characterized in that
by means of the connector on top surface of the adjacent carrier tracks disposed in opposite directions and/or at intervals, the adjacent carrier tracks slide in parallel under one channel of one rail; by alternating disposition of the connectors on top surface of each carrier track, the runners of the plurality of carrier tracks slide inside the same channel simultaneously;
thereby, while the runners of the plurality of carrier tracks inside a channel of a rail slide at the same time, the plurality of connecting/adjacent carrier tracks slide in parallel under the channel for extending or retracting the sliding panel.

2. The sliding panel as claimed in claim 1, wherein the adjacent carrier tracks having two, three or four carrier tracks.

3. The sliding panel as claimed in claim 1, wherein two connectors are arranged on top surface of each of the carrier tracks.

4. The sliding panel as claimed in claim 1, wherein when the adjacent carrier tracks are two carrier tracks, the connectors disposed on top surface of the two adjacent carrier tracks are arranged in opposite directions, the right side of the connectors on the left carrier track are inserted through the channel opening of the rail and connected with the runner inside the channel while the left side of the connectors on the right carrier track inserted through the same channel opening of the rail and connects with the other runner inside the channel so that the connectors of the left and right adjacent carrier tracks are respectively located at left and right sides under the channel opening of the rail; thus the left and right carrier tracks are side by side under the channel opening of the rail and slide in parallel to each other.

5. The sliding panel as claimed in claim 1, wherein when the adjacent carrier tracks are three carrier tracks, the connectors disposed on top surface of the two side carrier tracks are arranged in opposite directions and/or at intervals, the right side of the connector on the left carrier track is inserted through the channel opening of the rail and connected with the runner, the left side of the connector on the right carrier track is inserted through the channel opening of the rail and connects with the other runner while the middle connector of the middle carrier track between the left and right carrier tracks is inserted upward through the channel opening of the rail and connected with another runner so that the left, the middle, and the right carrier tracks are side by side under the channel opening of the rail and slide in parallel to one another.

6. The sliding panel as claimed in claim 1, wherein the rail comprising of an inner rail and an outer rail so that the inner rail and the outer rail can be telescoped for increasing/decreasing the length of the rail.

7. The sliding panel as claimed in claim 1, wherein the rail is disposed with a single channel.

8. The sliding panel as claimed in claim 1, wherein the rail set having a plurality of rails arranged in parallel.

9. The sliding panel as claimed in claim 8, wherein the rail set having one, two or three rails.

10. The sliding panel as claimed in claim 1, wherein the runner is a caster.

11. The sliding panel as claimed in claim 6, wherein a fixing clip is disposed between the outer rail and the inner rail; the fixing clip having two symmetrical arms and a stopping block while a projecting rod is disposed on rear end of each of the symmetrical arms so that the two projecting rods insert into two symmetrical holes on top surface of the outer rail and the fixing clip is pivotable; when the inner rail is pulled out of the outer rail into required length, the fixing clip is rotated to make the stopping block insert into a gap between the two adjacent inner rails so that relative position between the outer rail and the inner rail is fixed.

12. The sliding panel as claimed in claim 6, wherein a measuring tape is disposed on top surface of the inner rail.
